(19) United States
(12) Patent Application Publication
(10) Pub. No.: US 2026/0293846 A1
(43) Pub. Date: Oct. 1, 2026

(54) METHOD AND SYSTEM FOR CONTROLLING A WATERING PLANT FOR LABORATORY ANIMALS

(71) Applicant: TECNIPLAST S.P.A., Buguggiate (IT)

(72) Inventors: Pietro BERNARDINI, Casciago (IT); Carlo CHIORINO, Buguggiate (IT); Marco Giovanni Antonio BROCCA, Tradate (IT)

(21) Appl. No.: 19/490,239

(22) PCT Filed: Jun. 10, 2024
(86) PCT No.: PCT/IB2024/055650

§ 371 Date: Dec. 4, 2025

(30) Foreign Application Priority Data
Jun. 12, 2023 (IT) 102023000011943

(51) Int. Cl. A01K 7/02; A01K 1/03; A01K 29/00

(52) U.S. Cl. CPC A01K 7/02; A01K 1/0317; A01K 29/005

(57) ABSTRACT

Method for controlling a watering plant for laboratory animals by means of a system comprising a control unit and a first flow sensor connected to an inlet duct of the watering plant to transmit to the control unit signals corresponding to inflow values relating to the flow of liquid flowing in the inlet duct, which method comprises:

acquiring said inflow values;

sampling a series of consumption values which are indicative of the consumption of liquids in the watering plant and are obtained by processing the acquired inflow values;

calculating a mean value of the series of consumption values;

performing a statistical test to verify whether the mean value differs substantially from a reference mean value, in order to obtain a control statistical value;

detecting a possible anomaly in the watering plant based on the statistical control value.

### TECHNICAL FIELD

The present description concerns a method for controlling watering plants, in particular plants for watering laboratory animals housed in suitable laboratory containers. The present description also concerns a system that can carry out this method, an application that implements this method and a plant that comprises this system.

### BACKGROUND OF THE DESCRIPTION

The prior art describes a system for controlling watering plants, which system comprises a control unit connected to a flow sensor connected in turn to an inlet duct of a watering plant to transmit signals to the control unit corresponding to liquid flow values in the inlet duct. These signals are processed by the control unit to check whether the flow values exceed a certain threshold value, in which case the system generates an alarm.

A technical problem of this known system consists in the limited ability to distinguish between typical consumption and anomalous consumption, so that it may generate alarms even in the absence of a real anomaly in the watering plant. On the other hand, a lowering of the threshold value may cause false alarms, with the consequent risk of compromising the normal functioning of the watering plant, if not even the health of the laboratory animals that are watered by the plant.

Known systems for controlling liquid dispensing plants are described in documents WO 2019/117837 A1, CN 205691175 U, CN 206238004 U and CN 110178518 B.

### SUMMARY OF THE DESCRIPTION

The object of this description is therefore to provide a system that solves these problems. Said object is achieved with a system, a plant, a method and an application, the main features of which are specified in the attached claims, to be considered an integral part of the present description.

Thanks to the particular processing that is performed on inflow values, preferably in combination with outflow values, the system and method according to the present description allow a watering plant to be controlled more accurately, so as to avoid false alarms, in particular if magneto-inductive sensors are used and/or if a statistical test based on the mean values of liquid consumption in the watering plant is performed.

Said statistical test is preferably a Student's t-test which can also use, as a further test parameter, a standard deviation value of a series of liquid consumption values sampled in the watering plant, so as to automatically improve the precision and the reliability of the system and the method.

Furthermore, the system and the method allow to detect anomalies both in the absence and in the presence of circulation of liquids in the watering plant, as well as to calculate the volume of liquids consumed in the watering plant in an instantaneous and/or cumulative manner.

A particular embodiment of the system and/or of the method can also distinguish a normal operating state from a maintenance phase of the system itself, so as to avoid false alarms and/or calculate the volume of liquids consumed during maintenance.

The system and method can be easily installed, programmed via a specific application and adapted by a user and preferably comprise a particular alarm procedure, which allows further operations and checks to be performed in the watering plant when an anomaly is detected.

Further advantages and features of the system, plant, method and application according to the present description will be evident to those skilled in the art from the following detailed description of some embodiments, to be considered non-limiting examples of the claims, with reference to the attached drawings in which:

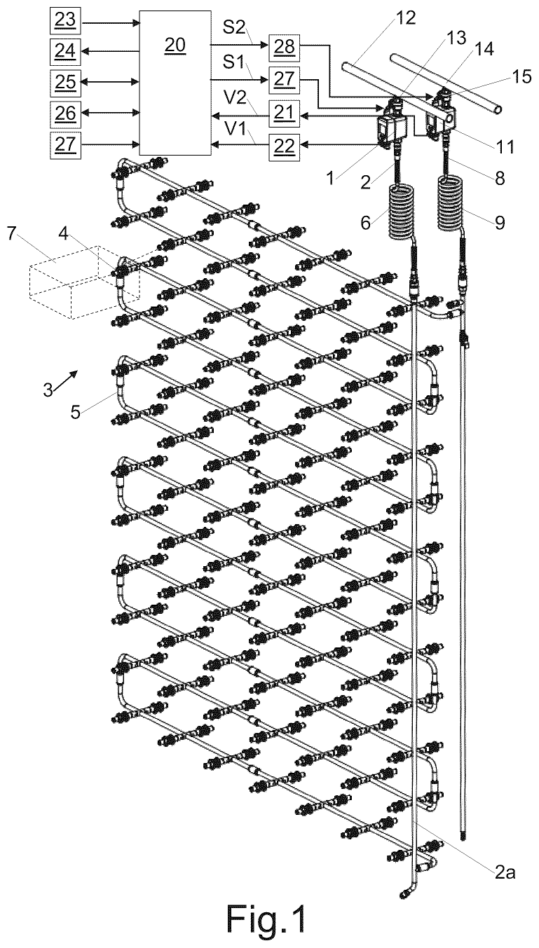

FIG. 1 is an axonometric and partially schematic view of a watering plant comprising embodiments of the system;

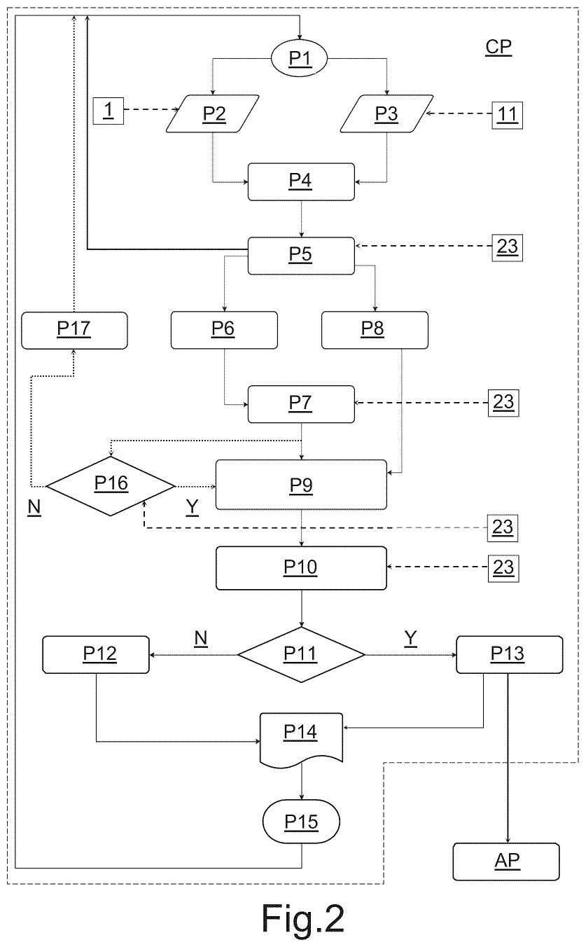

FIG. 2 is a flowchart of some steps of embodiments of the method;

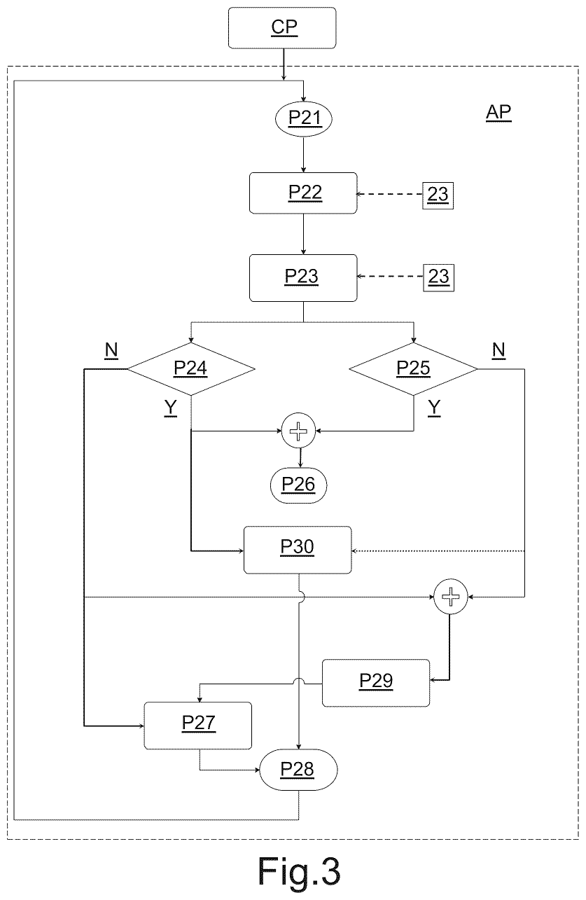

FIG. 3 is a flowchart of further steps of the method of FIG. 2.

### EXEMPLARY EMBODIMENTS

FIG. 1 shows a first embodiment of the system, which comprises a first flow sensor 1 configured to be connected to an inlet duct 2 of a watering plant 3 which comprises one or more fittings 4 which are connected to a distribution duct 5, which is in turn connected to the inlet duct 2, for example via a first auxiliary duct 6, in particular a flexible helical duct. A fitting 4 can in turn be connected to a watering device of a container 7 (shown with dotted lines) for laboratory animals, so that a liquid, in particular water, can flow from the inlet duct 2 to the watering device watering of the container 7 through the distribution duct 5 and the fitting 4 connected to this watering device. The container 7 can be arranged removably in a seat of the watering plant 3. Preferably, the watering plant 3 comprises a plurality of seats for containers 7 for laboratory animals, arranged in several horizontal rows and/or vertical columns on one or both sides of the distribution duct 5.

The inlet duct 2 may comprise a substantially straight portion 2a which extends from top to bottom in the watering plant 3, and/or the distribution duct 5 can have a flat serpentine shape which develops vertically in the watering plant 3, wherein the fittings 4 are connected to substantially straight and substantially horizontal sections of the flat serpentine.

The system preferably also comprises a second flow sensor 11 configured to be connected to an outlet duct 8 of the watering plant 3. The outlet duct 8 is connected to the distribution duct 5, for example via a second auxiliary duct 9, in particular a flexible helical duct.

Preferably, the first flow sensor 1 and/or the second flow sensor 11 are arranged along the inlet duct 2 and/or along the outlet duct 8, respectively, and/or comprise(s) a magnetic-inductive flow sensor for liquids, which preferably can also measure the consumption and temperature of liquids, in addition to the flow.

The inlet duct 2 can be connected to a supply duct 12, for example via a first valve 13, in particular a solenoid valve arranged along the inlet duct 2. The outlet duct 8 can be connected to a drain 14, for example through a second valve 15, in particular a solenoid valve arranged along the outlet duct 8. Further watering plants 3 can be connected to the supply duct 12 and to the drain 14 and can be provided with further flow sensors 1, 11 of the present system or of another system according to the present description.

The system also comprises a control unit 20 and the flow sensors 1, 11 are configured to transmit electrical or electromagnetic signals to the control unit 20, for example via connection devices 21, 22, in particular wireless devices, in so that the control unit 20 can receive from the flow sensors 1, 11 signals corresponding to inflow values V1 and outflow values V2 relating to the flow of liquid flowing respectively in the inlet duct 2 and in the outlet duct 8 of the watering plant 3.

The control unit 20 comprises and/or is connected to input means 23, for example a touchscreen and/or a keyboard, and/or to output means 24, for example a display and/or a printer, and/or to memory means 25, for example a RAM memory and/or a mass storage and/or a cloud storage, and/or to network means 26, for example a LAN network and/or the Internet, and/or to timing means 27, for example an internal clock or an external timer. The control unit 20 further comprises digital processing means, for example a microprocessor, for processing the flow values V1, V2 received from the flow sensors 1, 11, in particular by means of an application configured to be executed by the control unit 20 to implement the method according to the present description. The application can be stored in the memory means 25 and be executed by the control unit 20. The control unit 20 can belong for example to a PC, notebook, tablet, smartphone, server or other digital processor.

The control unit 20 can be configured to transmit electrical or electromagnetic signals to the first valve 13 and/or to the second valve 15 via interfaces 28, 29, so that the control unit 20 can send signals S1, S2 to the first valve 13 and/or to the second valve 15, respectively, to open or close the inlet duct 2 and/or the outlet duct 8, respectively.

With reference to FIG. 2, the present embodiment of the method comprises a control procedure CP where, after a first start-up phase P1, the control unit 20 acquires from the flow sensors 1, 11 inflow values V1 and outflow values V2 of the liquids which flow respectively in the inlet duct 1 and in the outlet duct 8 of the watering plant 3, respectively in two phases P2 and P3 which are preferably carried out substantially in parallel. In an alternative embodiment, the phase P3, in which the control unit 20 acquires the outflow values V2 from the flow sensor 11, is not carried out if the system does not comprise or does not use the second flow sensor 11.

In a phase P4 subsequent to the phases P2 and P3, the control unit 20 processes the inflow value V1, preferably in combination with the outflow value V2, to obtain a consumption value CV indicative of the consumption of liquids in the watering plant 3. In particular, the control unit 20 calculates the consumption value CV through a difference between an inflow value V1 and an outflow value V2, for example CV=V1-V2. If the phase P3 is not carried out, the consumption value CV is equal to the inflow value V1, i.e. CV=V1.

In a phase P5 subsequent to the phase P4, the control unit 20 adds the consumption value CV thus obtained to a series of consumption values CVi obtained previously (if it is not the first in the series), after which it restarts from the start phase P1 to acquire further consumption CV values until n CVi consumption values are sampled, with i=1 . . . n, with a given sampling frequency f. The number n of CVi consumption values to be sampled and the sampling frequency f are preferably set by a user via the input means 23.

After sampling the series of n consumption values CVi, in a phase P6 subsequent to the phase P5 the control unit 20 calculates a mean value MV of the series of n consumption values CVi, for example by performing an arithmetic mean of these values.

In a phase P7 subsequent to the phase P6, the control unit 20 can calculate a differential value DV relating to the difference between the mean value MV and a mean reference value MV′, for example DV=MV-MV′. The mean reference value MV′, if it has not already been calculated (see below), is preferably set by a user via the input means 23.

In a phase P8, preferably carried out substantially in parallel with the phases P6 and P7, the control unit 20 can also calculate a standard deviation value SDV of the series of n consumption values CVi.

In a phase P9 subsequent to the phase P7 and the phase P8, the control unit 20 carries out a statistical test to verify whether the mean value MV substantially differs from the mean reference value MV′, so as to obtain a control statistical value SV. Said statistical test is preferably a Student's t-test which uses, as test parameters, the mean value MV and the mean reference value MV′, or the corresponding differential value DV, as well as the standard deviation value SDV, to obtain the control statistical value SV.

In a phase P10 subsequent to the phase P9, the control statistical value SV is compared with a reference control value SV′, preferably set by a user through the input means 23. In the comparison between the control statistical value SV and the reference control value SV′, the control unit 20 can determine whether the control statistical value SV is greater than the reference control value SV′, i.e. whether SV>SV′.

In a phase P11 subsequent to phase P10, depending on the positive (SV>SV′) or negative (SV<=SV′) outcome of said comparison between the statistical control value SV and the reference control value SV′, the control unit 20 can carry out a phase P12 if the outcome is negative (N), or, alternatively, a phase P13 if the outcome is positive (Y). The positive outcome may therefore correspond to an anomaly found by the control procedure CP in the watering plant 3.

In the phase P12 the control unit 20 calculates a further mean value MV″ between the mean value MV and the set mean reference value MV′ and replaces this mean reference value MV′ with the further mean value MV″ obtained through this calculation, so as to set a new mean reference value MV′, i.e. MV′=MV″.

In the phase P13 alternative to the phase P12 the control unit 20 can calculate a volume value VV indicative of the volume of liquid consumed in the watering plant 3 during the sampling duration, in particular a volume value VV corresponding to the sum of the consumption values CVi, for example VV=CV1+CV2+. . . +CVn. In the phase 13 the control unit 20 can also start an alarm procedure AP configured to signal an anomaly in the watering plant 3.

In a phase P14 subsequent to the phase P12 or the phase P13, the control unit 20 can store in the memory means 25 and/or transmit to the output means 24 and/or to the network means 26 a series of data, in particular a file, which comprise the mean reference value MV′ and/or the volume value VV.

In a phase P15 subsequent to the phase P14, the control unit 20 can restart the control procedure CP starting from the phase P1.

A preferred embodiment of the method, shown with the dotted arrows in FIG. 2, comprises after the phase P7 a phase P16, in which the mean value MV or the corresponding differential value DV are compared with a limit value LV preferably set by a user through the input means 23. If the mean value MV and/or the corresponding differential value DV is less (Y) than the limit value LV, i.e. MV<LV and/or DV<LV, the statistical test of the phase P9 is carried out. If the mean value MV or the corresponding differential value DV is not less (N) than the limit value LV, the phase P9 is not carried out as the system may be in a transient state of maintenance, in particular a flushing state of the system, so that a phase P17 can be carried out in which a limit volume value LVV of liquid consumed during this limit state is calculated. The limit volume value LVV is calculated by adding the mean value MV to a summation of mean values MV, in particular previously measured mean values MV, and starting cyclically from the phase P1, until the mean value MV or the corresponding differential value DV is not less than the limit value LV, so that phase P9 is carried out again. The limit volume value LVV can be stored in the memory means 25 and/or transmitted to the output means 24 and/or to the network means 26. Therefore, in this embodiment the statistical test of the phase P9 is carried out or not carried out depending on the result of a comparison of the mean value MV or the differential value DV with the limit value LV.

With reference to FIG. 3, a possible alarm procedure AP can comprise a first phase P21 where a timer, for example implemented by the timing means 27, is started at a time t=0.

In a phase P22 subsequent to the phase P21, the control unit 20 calculates a cumulative volume value CVV obtained by adding, in a given observation period OT, the volume values VV corresponding to the volumes of liquid consumed by the watering plant 3 in case of anomalous consumption detected in the phase P13 of the control procedure CP. The observation period OT is preferably set by a user via the input means 23.

In a phase P23 subsequent to the phase P22 the control unit 20 compares the cumulative volume value CVV with a reference volume value CVV′ which is preferably set by a user through the input means 23.

In a phase P24 subsequent to the phase P23, the control unit 20 checks whether the timer has not concluded the observation period OT, i.e. whether t<OT.

In a phase P25 carried out substantially in parallel with the phase P24, the control unit 20 also checks whether the cumulative volume value CVV is equal to or greater than the reference volume value CVV′, i.e. whether CVV=>CVV′.

In a phase P26 subsequent to the phase P24, if the result of both checks performed in the phases P24 and P25 is positive (Y), then the control unit 20 may activate an alarm, in particular by generating an alarm signal, for example a visual and/or acoustic signal emitted by the output means 24 and/or a digital signal transmitted by the network means 26 to other digital units. In the phase P26 the control unit 20 may also generate one or more signals S1 and/or S2 to open or close the first valve 13 and/or the second valve 15, or to control other electrical or electronic devices.

In a phase P27 subsequent to the phase P24, if the outcome of the control of phase P24 is negative (N), i.e. if the timer has concluded the observation period OT, in particular if t=>OT, then the control unit 20 resets the timer, i.e. t=0.

In a phase P28 subsequent to the phase P27, the control unit 20 restarts the alarm procedure AP starting from the phase P21.

In a P29 phase subsequent to the phase P24, if the outcome of the control of phase P24 is negative (N) and the outcome of the control of the phase P25 is also negative (N), i.e. if also the cumulative volume value CVV is less than the reference volume value CVV′, in particular if CVV<CVV′, then the control unit 20 updates the cumulative volume value CVV as follows:
a. if the cumulative volume value CVV is not zero and is less than a lower threshold value CVV1, then the control unit 20 resets the cumulative volume value CVV to zero, i.e. if 0<CVV<CVV1 then CVV=0;
b. if the cumulative volume value CVV is less than the reference value CVV′ and is greater than an upper threshold value CVV2, then the control unit 20 adds an additional value CVV3 to the cumulative volume value CVV, i.e. if CVV2<CVV<CVV′ then CVV=CVV+CVV3.

The lower threshold value CVV1, the upper threshold value CVV2 and/or the additional value CVV3 are preferably set by a user via the input means 23.

After updating the cumulative volume value CVV in the phase P29, the control unit 20 goes to the phase P27, i.e. it resets the timer, and from the phase P28 the alarm procedure AP restarts from the phase P21.

In a phase P30 subsequent to the phase P24, if the outcome of the control of the phase P24 is positive (Y), i.e. if the timer has not concluded the observation period OT, in particular if t<OT, then the control unit 20 increases the timer by a sampling period, i.e. t=t+(n/f), after which the control unit 20 goes to the phase P28 to restart the alarm procedure AP from the phase P21.

A simplified embodiment of the method, shown with the dotted arrow in FIG. 3, does not comprise the phase P29, so that the phase P30 is carried out if the outcome of the control of the phase P25 is negative (N).

Therefore, the control unit 20 is configured to process the inflow values V1, preferably in combination with the outflow values V2, in particular through an application implementing the method according to the present description, so as to detect a possible anomaly in the watering plant 3.

Variants or additions can be made by those skilled in the art to the embodiments described and illustrated herein while remaining within the scope of the following claims. In particular, further embodiments may comprise the technical features of one of the following claims with the addition of one or more technical features described in the specification or illustrated in the drawings, taken individually or in any reciprocal combination and comprising their equivalent features.

Furthermore, the terms “a/an/one”, “two”, etc. in the description and claims respectively mean “at least one”, “at least two”, etc., unless otherwise specified. Similarly, angles, aspect ratios and values mentioned in the specification and/or shown in the drawings comprise a tolerance of at least 5%, unless otherwise specified.

1. A method for controlling a watering plant for laboratory animals by means of a system comprising a control unit and a first flow sensor connected to an inlet duct of the watering plant to transmit to the control unit signals corresponding to inflow values relating to the flow of liquid flowing in the inlet duct, which method comprises:
acquiring said inflow values;
sampling a series of consumption values which are indicative of the consumption of liquids in the watering plant and are obtained by processing the acquired inflow values;
calculating a mean value of the series of consumption values;
performing a statistical test to verify whether the mean value differs substantially from a reference mean value, in order to obtain a control statistical value;
detecting a possible anomaly in the watering plant based on the statistical control value.

2. The method according to claim 1, wherein said system also comprises a second flow sensor connected to an outlet duct of the watering plant to transmit to the control unit signals corresponding to outflow values relating to the flow of liquid flowing in the outlet duct, wherein the method also comprises:
acquiring said outflow values;
processing the acquired inflow values in combination with the acquired outflow values to obtain said series of consumption values which are indicative of the consumption of liquids in the watering plant.

3. The method according to claim 1, wherein said statistical test is a Student's t-test which uses, as test parameters, the mean value and the mean reference value, or a differential value relating to the difference between the mean value and the mean reference value, as well as a standard deviation value of the series of consumption values.

4. The method according to claim 1, wherein the anomaly in the watering plant is detected by comparing the statistical control value with a reference control value.

5. The method according to claim 1, wherein, if an anomaly is not detected in the watering plant, a further mean value is calculated between the mean value and the mean reference value and this mean reference value is replaced by the additional mean value obtained through this calculation.

6. The method according to claim 1, wherein, if an anomaly is detected in the watering plant, an alarm procedure configured to signal this anomaly is carried out.

7. The method according to claim 1, wherein, if an anomaly is detected in the watering plant, a volume value is calculated indicative of the volume of liquid consumed in the watering plant during the sampling duration.

8. The method according to claim 7, wherein the anomaly in the watering plant is signaled according to the result of a comparison between a cumulative volume value and a reference volume value, wherein the cumulative volume value is obtained by adding a plurality of volume values calculated in a given observation period.

9. The method according to claim 1, wherein said statistical test is carried out or not carried out depending on the result of a comparison of said mean value with a limit value.

10. The method according to claim 9, wherein, if said statistical test is not carried out, a limit volume value is calculated by adding the mean value to a summation of mean values and starting again from the acquisition of said inflow values.

11. The method according to claim 10, wherein the mean value is added to the summation of mean values until said statistical test is carried out again.

12. The method according to claim 4, wherein the reference mean value and/or the reference control value are set by a user.

13. The method according to claim 8, wherein the reference volume value and/or the observation period are set by a user.

14. An application configured to be executed by a control unit and to implement the method according to claim 1.

15. A system for controlling a watering plant for laboratory animals, which system comprises a control unit and a first flow sensor configured to be connected to an inlet duct of a watering plant and to transmit signals to the control unit, so that the control unit can receive from the first flow sensor, and process, signals corresponding to inflow values relating to the flow of liquid flowing in the inlet duct, wherein the system is configured to carry out the method according to claim 1.

16. The system according to claim 15, wherein the system also comprises a second flow sensor configured to be connected to an outlet duct of the watering plant and to transmit signals to the control unit, so that the control unit can receive from the second flow sensor, and process, signals corresponding to outflow values relating to the flow of liquid flowing in the outlet duct.

17. The system according to claim 15, wherein the control unit is configured to transmit signals to a first valve arranged along the inlet duct and/or to a second valve arranged along the outlet duct, so that the control unit can send signals to these valves to open or close the inlet duct and/or the outlet duct, respectively.

18. The system according to claim 16, wherein the first flow sensor and/or the second flow sensor comprise(s) a magneto-inductive flow sensor for liquids.

19. The system according to claim 15, wherein the control unit is configured to process the inflow values and/or the outflow values to detect a possible anomaly of the watering plant.

20. A watering plant for laboratory animals, which comprises one or more fittings which are connected to a distribution duct, which is in turn connected to an inlet duct and to an outlet duct, wherein the fittings are configured to be connected to watering devices of containers for laboratory animals, wherein the inlet duct and/or the outlet duct are connected to the first flow sensor and/or to the second flow sensor, respectively, of the system according to claim 15.
